(19) United States
(12) Patent Application Publication
(10) Pub. No.: US 2025/0177813 A1
(43) Pub. Date: Jun. 5, 2025

(54) PASSIVE EXOSUIT FOR ASYMMETRY REHABILITATION

(71) Applicant: Board of Regents of the University of Nebraska, Lincoln, NE (US)

(72) Inventors: Kayla KOWALCZYK, ATHENS, GA (US); Philippe MALCOLM, OMAHA, NE (US); Takashi SADO, OMAHA, NE (US)

(73) Assignee: Board of Regents of the University of Nebraska, Lincoln, NE (US)

(21) Appl. No.: 18/843,165

(22) PCT Filed: Mar. 31, 2023
(86) PCT No.: PCT/US2023/065201

§ 371 Date: Aug. 30, 2024

Related U.S. Application Data
(60) Provisional application No. 63/325,922, filed on Mar. 31, 2022.

(51) Int. Cl. A63B 23/04; A41D 27/00; A63B 21/00; A63B 21/04; A63B 21/055

(52) U.S. Cl. CPC A63B 23/0482; A41D 27/00; A63B 21/00185; A63B 21/0407; A63B 21/0552; A63B 21/4005; A63B 21/4007; A63B 21/4011

(57) ABSTRACT

A passive exosuit for asymmetry rehabilitation includes: a first article of apparel configured to be worn on at least a portion of the first leg of the user; a second article of apparel configured to be worn on at least a portion of the second leg of the user; a third article of apparel configured to be worn on at least a portion of a torso of the user; and a plurality of clastic bands asymmetrically connecting the third article of apparel to the first and second articles of apparel. The elastic bands include at least one anterior band configured to impede hip extension of the first leg of the user and at least one posterior band configured to impede hip flexion of the second leg of the user.

### CROSS-REFERENCE TO RELATED APPLICATIONS

The present application claims priority under 35 U.S.C. § 119 (e) to U.S. Provisional Application Ser. No. 63/325,922, filed Mar. 31, 2022, and titled “Passive Hip Exoskeleton,” which is incorporated herein by reference in its entirety.

### STATEMENT OF GOVERNMENT SUPPORT

This invention was made with U.S. government support under grant number P20 GM109090 awarded by the National Institutes of Health (NIH). The U.S. government has certain rights in the invention.

### TECHNICAL FIELD

The present invention generally relates to systems and methods for physical rehabilitation, more specifically to systems and methods for remediating asymmetric gait.

### BACKGROUND

The ability to walk efficiently allows humans to maintain active, healthy lifestyles and complete activities of daily living with ease. Motor control pathways in the central nervous system communicate with the peripheral nerves of the lower extremity joints to advance the body forward during walking.

Neurological disorders, such as stroke or Multiple Sclerosis, damage the central nervous system interrupting communication to the periphery leading to asymmetric walking patterns. Asymmetric walking gait patterns consist of reduced lower extremity range of motion, step lengths, preferred walking speed, and altered stance times. These altered or asymmetric walking patterns lead to an increased risk of falls and limit the mobility needed to perform common tasks.

Vascular disorders, such as Peripheral Artery Disease (PAD), may cause an increase in pain during walking leading to reduced mobility, walking speed, endurance, and leg strength. The inability to walk for long periods of time or exercise triggers disease propagation and worse functional outcomes.

Improving mobility and quality of life for vascular and neurological populations remains an issue today. Previously, the main forms of rehabilitation for asymmetric gait included unilateral weighting and split-belt treadmill walking. Although these techniques have been shown to provide short-term improvements in symmetry, long-term aftereffects did not persist. Furthermore, weighting the ankle may impart an unneeded burden on patients and access to split-belt treadmills are not readily available or accessible.

To attain long-term alterations to asymmetric gait patterns and to increase walking ability in patient populations, commercially available devices that can be worn for long periods of time are necessary. Providing passive assistance during daily activities has the potential to improve users' quality of life. Providing a comfortable way to improve walking gait has the potential to revolutionize rehabilitation methods and produce long-term improvement retention.

### SUMMARY

A passive exosuit for asymmetry rehabilitation is disclosed. In embodiments, the passive exosuit includes: a first article of apparel configured to be worn on at least a portion of a first leg of a user; a second article of apparel configured to be worn on at least a portion of a second leg (different from the first leg) of the user; a third article of apparel configured to be worn on at least a portion of a torso of the user; and a plurality of elastic bands asymmetrically connecting the third article of apparel to the first and second articles of apparel. In embodiments, the elastic bands include at least one anterior band configured to impede hip extension of the first leg of the user and at least one posterior band configured to impede hip flexion of the second leg of the user.

Although bilateral embodiments of the passive exosuit (as described above) are the focus of this disclosure, a unilateral embodiment of the passive exosuit is also provided. In a unilateral embodiment, the passive exosuit includes: an article of apparel configured to be worn on at least a portion of a torso of a user; another article of apparel configured to be worn on at least a portion of a selected leg of the user; and at least one elastic band connecting the articles of apparel to one another, the at least one elastic band comprising at least one anterior band configured to impede hip extension of the selected leg of the user or at least one posterior band configured to impede hip flexion of the selected leg of the user.

Methods for asymmetry rehabilitation are also disclosed. In implementations, a method of performing asymmetry rehabilitation includes steps of: (i) assessing gait asymmetry affecting a user by determining a difference between step lengths when advancing with a first leg of the user versus advancing with a second leg of the user; and (ii) donning the passive exosuit on the user, wherein the elastic bands are configured to increase the difference between the step lengths when advancing with the first leg of the user versus advancing with the second leg of the user, thereby causing the user to overcompensate for the difference between the step lengths while wearing the passive exosuit and then walk with improved gait symmetry upon removing the passive exosuit as a result of said overcompensation.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is provided with reference to the accompanying figures. The use of the same reference numbers in different instances in the description and the figures may indicate similar or identical items. Various embodiments or examples of the present disclosure are provided in the following detailed description and the accompanying drawings. The drawings are not necessarily to scale. Furthermore, operations of disclosed processes may be performed in an arbitrary order, unless otherwise indicated in the detailed description or in the claims.

FIG. 1 is a side-by-side comparison of (A) an asymmetric step pattern without a passive exosuit for asymmetry rehabilitation and (B) an exaggerated asymmetric step pattern resulting from use of a passive exosuit for asymmetry rehabilitation, in accordance with one or more embodiments of this disclosure.

FIG. 2 is a perspective view of a passive exosuit for asymmetry rehabilitation, in accordance with one or more embodiments of this disclosure.

FIG. 3A is a rear view of the passive exosuit of FIG. 2, in accordance with one or more embodiments of this disclosure.

FIG. 3B is a front view of the passive exosuit of FIG. 2, in accordance with one or more embodiments of this disclosure.

FIG. 4 is a side view of a passive exosuit for asymmetry rehabilitation, in accordance with one or more embodiments of this disclosure.

FIG. 5A is a front view of the passive exosuit of FIG. 4, in accordance with one or more embodiments of this disclosure.

FIG. 5B is a rear view of the passive exosuit of FIG. 4, in accordance with one or more embodiments of this disclosure.

FIG. 6 is a side view of a passive exosuit for asymmetry rehabilitation, wherein the passive exosuit is configured to be worn underneath a user's clothing, in accordance with one or more embodiments of this disclosure.

FIG. 7A is a front view of the passive exosuit of FIG. 6, in accordance with one or more embodiments of this disclosure.

FIG. 7B is a rear view of the passive exosuit of FIG. 6, in accordance with one or more embodiments of this disclosure.

FIG. 8A is a front view of the passive exosuit of FIG. 6, wherein the passive exosuit is partially covered by the user's clothing, in accordance with one or more embodiments of this disclosure.

FIG. 8B is a front view of the passive exosuit of FIG. 6, wherein the passive exosuit is fully covered by the user's clothing, in accordance with one or more embodiments of this disclosure.

FIG. 9A is a rear view of a passive exosuit for asymmetry rehabilitation, in accordance with one or more embodiments of this disclosure.

FIG. 9B is a front view of the passive exosuit of FIG. 9A, in accordance with one or more embodiments of this disclosure.

FIG. 10A is a front view of a passive exosuit for asymmetry rehabilitation, in accordance with one or more embodiments of this disclosure.

FIG. 10B is a rear view of the passive exosuit of FIG. 10A, in accordance with one or more embodiments of this disclosure.

FIG. 11A is a front view of a passive exosuit for asymmetry rehabilitation, wherein the passive exosuit includes a mechanism for adjusting tension of a posterior elastic band using a dial located at the front of the passive exosuit, in accordance with one or more embodiments of this disclosure.

FIG. 11B is a rear view of the passive exosuit of FIG. 11A, in accordance with one or more embodiments of this disclosure.

FIG. 12A is a front view of a passive exosuit for asymmetry rehabilitation, in accordance with one or more embodiments of this disclosure.

FIG. 12B is a rear view of the passive exosuit of FIG. 12A, in accordance with one or more embodiments of this disclosure.

### DETAILED DESCRIPTION

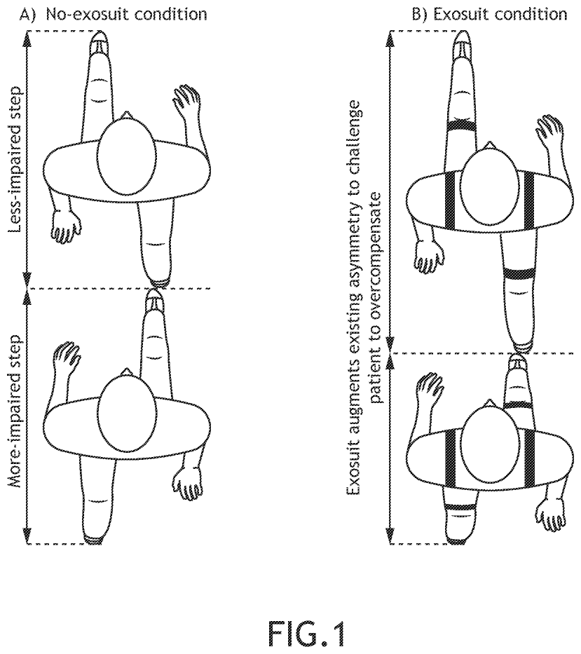

The present disclosure is directed to a passive exosuit for asymmetry rehabilitation. FIG. 1 illustrates an example side-by-side comparison of (A) an asymmetric step pattern without the passive exosuit and (B) an exaggerated asymmetric step pattern resulting from use of the passive exosuit. The passive exosuit is an asymmetric exosuit that augments existing asymmetry in a user's gait to produce a more symmetrical gait after training with the device. As shown in FIG. 1, asymmetry is increased when wearing the passive exosuit, thereby challenging the user to overcompensate (more than usual). Improved gait symmetry occurs as an aftereffect of the user's overcompensation while wearing the device because the user has been trained to exert even more force than they normally would to overcompensate for a difference between their step length when advancing with one leg versus their step length when advancing with their other leg.

In the early 2000s, it was discovered that a treadmill with two separate belts that move at different speeds could reduce asymmetry in stroke patients. Forcing the leg that normally takes shorter steps to take longer steps leads to an adaptation that results in a temporarily more symmetric gait after the training. However, further research has revealed several limitations: When the effects are measured overground, they appear reduced by ˜45% compared to walking on the treadmill, which is needed for the training. In addition, the effects appear specific to the chosen treadmill speeds. Finally, long-term retention only occurs in half of the patients and requires several weeks of training with an expensive treadmill that is not commonly available.

The passive exosuit aims to address the above limitations. Using a wearable garment that allows for overground training eliminates the need to transfer learned patterns from the treadmill. Training overground will, in turn, lead to more variable-speed practice. Thanks to its comparatively low cost, the passive exosuit can be used at home and during real life, enabling a far greater training dose and longer retention on the order of what can be expected from very long adaptation paradigms. Crucially, the passive exosuit combines resistance training, constraint-induced therapy, and leg swing assistance, thereby addressing the call for investigating multimodal therapies.

Different groups have developed wearable devices that assist paretic leg propulsion. However, meta-analysis studies and Cochrane reviews now strongly demonstrate that robotic assistance training does not improve walking endurance more than conventional therapy. This is because assistance makes patients reliant on the device, resulting in lesser gains once the assistance is removed. To avoid making the patient dependent on assistance, the passive exosuit is configured as a training device rather than an assistive device. Other groups have employed an exoskeleton to create adaptation effects that could potentially be useful in stroke rehabilitation. A key difference is that they use a rigid exoskeleton powered with an off-board power source. The off-board power source would eliminate the advantage of variable-speed overground training. Furthermore, using a rigid exoskeleton typically leads to a relatively larger mass and relative motion between the device and the person due to imperfections in the fit.

Using a design based on fabric and elastic bands, the passive exosuit is more lightweight (e.g., weighing about 1 kg) and more comfortable than rigid and powered exoskeletons. Thanks to the very low cost of the materials (e.g., about $40), it is highly feasible to distribute passive exosuits, as disclosed herein, for training at home. This low cost and high reproducibility will empower patients in remote areas to train for the needed durations to achieve functional improvements.

In preferred embodiments, the passive exosuit is a bilateral asymmetric device that stores and returns elastic energy from bands in parallel with the hip flexors and extensors during walking gait. For example, the passive exosuit may be configured to store energy in one or more anterior elastic bands as one hip extends during walking and configured to store energy in one or more posterior elastic bands as the other hip flexes during walking. An advantage of the passive exosuit is that no external power source is required to provide passive assistance, and the passive exosuit adds energy availability throughout the entirety of the walking gait cycle.

The passive exosuit may include thigh braces and shoulder straps and/or a back/abdominal brace, optionally with multiple connection points for the elastic bands in order to accommodate for different body sizes. Although the passive exosuit is preferably a bilateral asymmetric device, unilateral embodiments are also contemplated and described herein.

Goals of the passive exosuit include, but are not limited to, reducing asymmetric gait patterns through prolonged training with the device and providing a new form of rehabilitation outside of clinical or laboratory settings. The intended populations for use of the passive exosuit include, but are not limited to, stroke, Multiple Sclerosis, peripheral artery disease, or any population suffering from asymmetric walking gait patterns. The passive exosuit may also be beneficial for biomechanics testing and research, physical therapy of a multitude of injuries and diseases, and sports or athletic performance training.

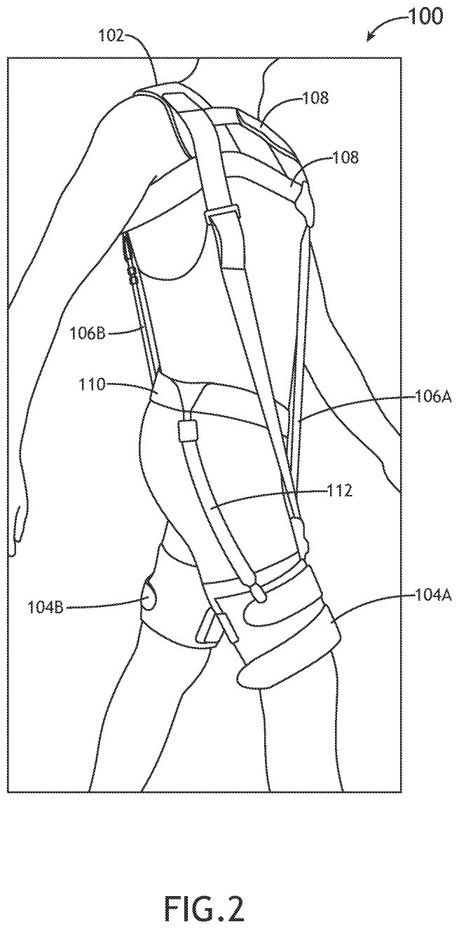

Example embodiments of the passive exosuit are discussed below with reference to FIGS. 2 through 12B. Those skilled in the art will appreciate that the embodiments illustrated in FIGS. 2 through 12B are specific examples that can be modified by changing dimensions, rearranging components, adding/removing non-essential components or fillers, and/or replacing components with functional equivalents. Furthermore, two or more embodiments (or portions thereof) can be combined to achieve an additional embodiment that is not necessarily shown or described with reference to one drawing. As such, the drawings should not be construed as restrictive of any particular embodiment and are intended instead as visual aids to help describe configurations of certain components that may apply to multiple embodiments of the passive exosuit.

Referring first to embodiments illustrated in FIGS. 2 through 11B, the passive exosuit is preferably both bilateral and asymmetric. As described in further detail below, the passive exosuit may include: a first article of apparel configured to be worn on at least a portion of a first leg of a user; a second article of apparel configured to be worn on at least a portion of a second leg (different from the first leg) of the user; a third article of apparel configured to be worn on at least a portion of a torso of the user; and a plurality of elastic bands asymmetrically connecting the third article of apparel to the first and second articles of apparel. The elastic bands include at least one anterior band configured to impede hip extension of the first leg of the user and at least one posterior band configured to impede hip flexion of the second leg of the user.

FIG. 2 illustrates an embodiment of a passive exosuit 100, wherein the first and second articles of apparel are thigh braces 104A and 104B, and wherein the third article of apparel is a pair of shoulder straps 102. The first thigh brace 104A is configured to be worn on a user's first leg and the second thigh brace 104B is configured to be worn on a user's second leg. As used herein, the “first leg” refers to one of the user's right or left legs and the “second leg” refers to the other one of the user's right or left legs. However, no specific order is intended.

The thigh braces 104A and 104B may be secured about the user's first and second legs, respectively. In some embodiments, the thigh braces 104A and 104B wrap around the leg just above the knee. The thigh braces 104A and 104B may be secured by embedded elastic bands, straps, hook and loop fasteners (e.g., Velcro), buttons, buckles, clasps, any combination of the foregoing fasteners, or the like.

The shoulder straps 102 are coupled to the thigh braces 104A and 104B by one or more anterior elastic bands 106A extending from the shoulder straps 102 to the first thigh brace 104A and one or more posterior elastic bands 106B extending from the shoulder straps 102 to the second thigh brace 104B. The anterior band(s) 106A may be configured to impede hip extension of the first leg of the user, and the posterior band(s) 106B may be configured to impede hip flexion of the second leg of the user, or vice versa.

The elastic bands 106A and 106B may be further configured to assist movement in the opposite direction. This allows for energy to be stored and released throughout the entirety of the walking gait cycle. For example, energy is stored in the anterior band(s) 106A when impeding hip extension of the first leg while stepping forward with the second leg; using this energy, the anterior band(s) 106A can assist hip flexion of the first leg when the first leg is used to step forward. Similarly, energy is stored in the posterior band(s) 106B when impeding hip flexion of the second leg while stepping forward with the second leg; using this energy, the posterior band(s) 106B can assist hip extension of the second leg when the first leg is used to step forward.

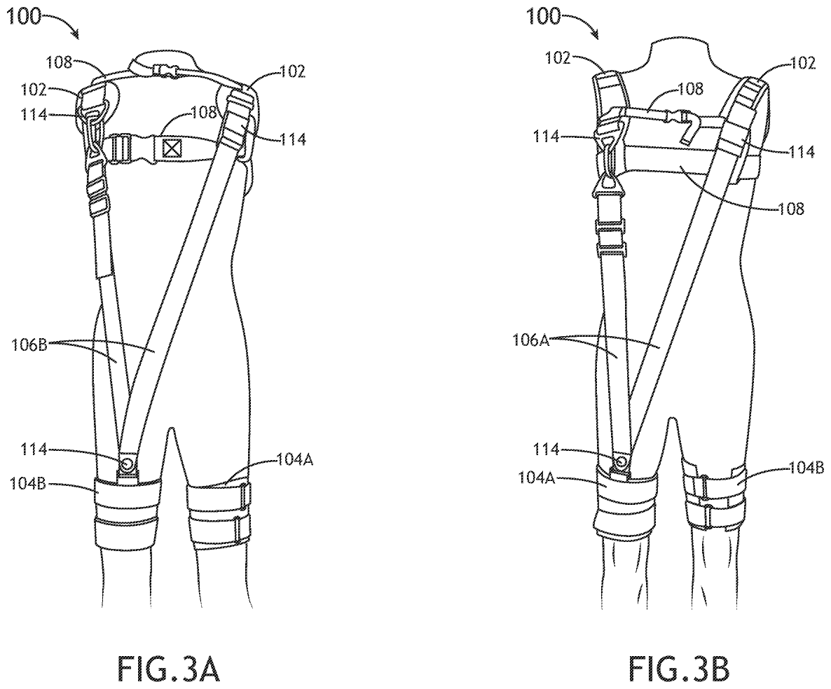

As shown in FIG. 3B, the anterior elastic bands 106A may be comprised of two or more elastic bands connecting the shoulder straps 102 to the first thigh brace 104A in order to distribute hip extension impedance forces more evenly across the torso (e.g., across both shoulders). Similarly, as shown in FIG. 3A, the posterior elastic bands 106B may be comprised of two or more elastic bands connecting the shoulder straps 102 to the second thigh brace 104B in order to distribute hip flexion impedance forces more evenly across the torso (e.g., across both shoulders).

Although specific embodiments are described above, it is contemplated that any number of anterior bands 106A and any number of posterior bands 106B may be utilized as long as they are arranged asymmetrically (i.e., anterior band(s) 106A connected to the front of the first leg and posterior band(s) 106B connected to the back of the second leg).

In some embodiments, the elastic bands 106A and 106B are adjustable length bands to provide different tensioning relationships during walking. The elastic bands 106A and 106B may be polymer resistance bands or any other type of stretchable polymer and/or fabric with appropriate strength and resilience. As shown in FIGS. 3A and 3B, the elastic bands 106A and 106B may be coupled to the shoulder straps 102 and/or to the thigh braces 104A and 104B by a plurality of fasteners 114. In some embodiments, the fasteners 114 allow for the elastic bands 106A and 106B to be removably coupled so that elastic bands can be replaced or to allow for use of elastic bands with different levels of resistance, different dimensions, different weight ratings, etc. In some embodiments, the anterior band(s) 106A may have a different level of resistance, dimension, and/or weight rating than the posterior band(s) 106B. The anterior band(s) 106A and posterior band(s) 106B can also be independently adjustable. The fasteners 114 may also be configured to provide a mechanism for adjusting band tension (e.g., by tightening or loosening bands or by connecting the bands to different fastener locations). In embodiments, the fasteners 114 may include, but are not limited to, buttons, buckles, clasps, latches, clips, snap fasteners, loop fasteners, hook and eye fasteners, hook and loop fasteners (e.g., Velcro), seatbelt buckles, or any combination thereof.

The passive exosuit 100 may further include one or more chest straps 108 extending between the pair of shoulder straps 102 for added support. As shown in FIGS. 3A and 3B, chest straps 108 be secured across the front and/or back of the passive exosuit 100. As shown in FIG. 2, the passive exosuit 100 may also include a waist belt 110 with suspenders 112 extending from the waist belt 110 to the thigh braces 104A and 104B for added support. The waist belt 110 with suspenders 112 is configured much like a suspender belt or garter belt.

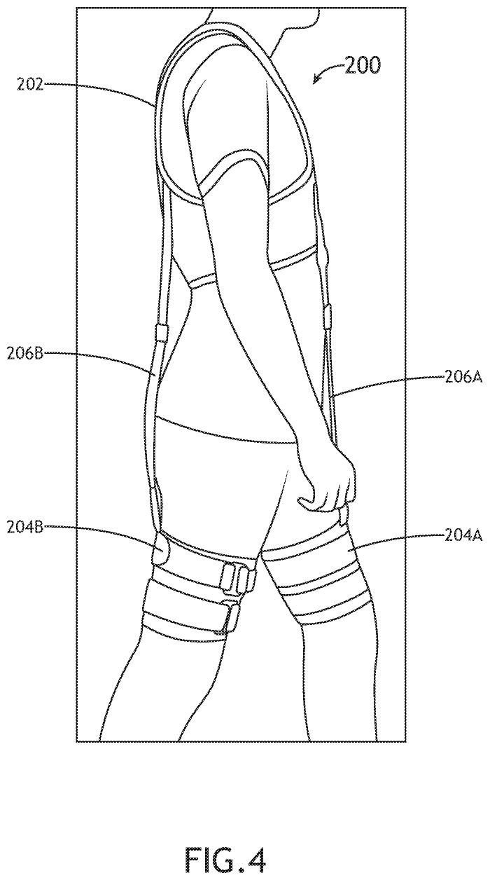

FIG. 4 illustrates another embodiment of a passive exosuit 200, wherein the first and second articles of apparel are thigh braces 204A and 204B, and wherein the third article of apparel is a vest 202 making the exosuit 200 easy to wear and providing additional support about the user's torso. The first thigh brace 204A is configured to be worn on a user's first leg and the second thigh brace 204B is configured to be worn on a user's second leg.

The thigh braces 204A and 204B may be secured about the user's first and second legs, respectively. In some embodiments, the thigh braces 204A and 204B wrap around the leg just above the knee. The thigh braces 204A and 204B may be secured by embedded elastic bands, straps, hook and loop fasteners (e.g., Velcro), buttons, buckles, clasps, any combination of the foregoing fasteners, or the like.

The vest 202 is coupled to the thigh braces 204A and 204B by one or more anterior elastic bands 206A extending from the vest 202 to the first thigh brace 204A and one or more posterior elastic bands 206B extending from the vest 202 to the second thigh brace 204B. The anterior band(s) 206A may be configured to impede hip extension of the first leg of the user, and the posterior band(s) 206B may be configured to impede hip flexion of the second leg of the user, or vice versa.

The elastic bands 206A and 206B may be further configured to assist movement in the opposite direction. This allows for energy to be stored and released throughout the entirety of the walking gait cycle. For example, energy is stored in the anterior band(s) 206A when impeding hip extension of the first leg while stepping forward with the second leg; using this energy, the anterior band(s) 206A can assist hip flexion of the first leg when the first leg is used to step forward. Similarly, energy is stored in the posterior band(s) 206B when impeding hip flexion of the second leg while stepping forward with the second leg; using this energy, the posterior band(s) 206B can assist hip extension of the second leg when the first leg is used to step forward.

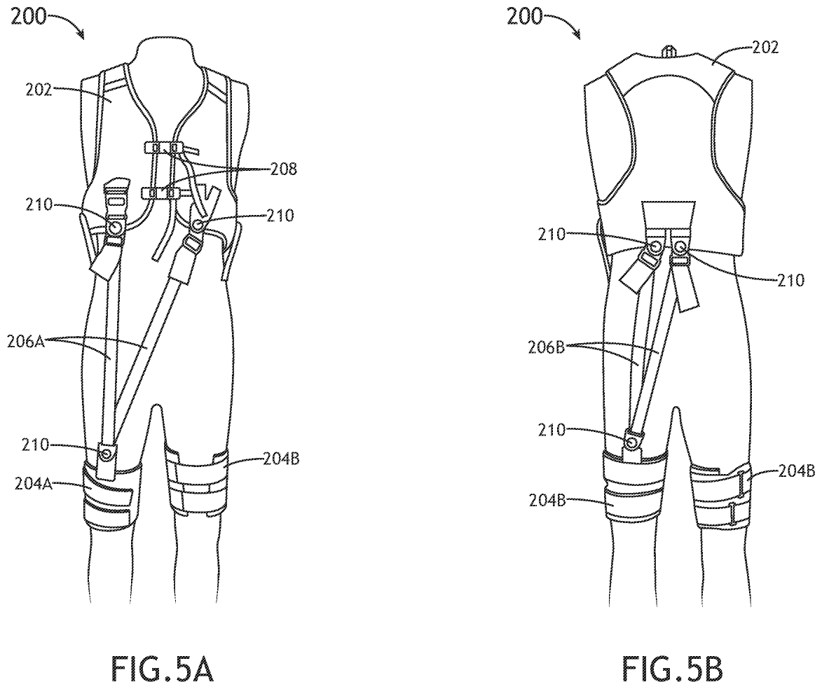

As shown in FIG. 5A, the anterior elastic bands 206A may be comprised of two or more elastic bands connecting the vest 202 to the first thigh brace 204A in order to distribute hip extension impedance forces more evenly across the torso (e.g., across both sides of the shoulders, chest, back, etc.). Similarly, as shown in FIG. 5B, the posterior elastic bands 206B may be comprised of two or more elastic bands connecting the vest 202 to the second thigh brace 204B in order to distribute hip flexion impedance forces more evenly across the torso (e.g., across both sides of the shoulders, chest, back, etc.).

Although specific embodiments are described above, it is contemplated that any number of anterior bands 206A and any number of posterior bands 206B may be utilized as long as they are arranged asymmetrically (i.e., anterior band(s) 206A connected to the front of the first leg and posterior band(s) 206B connected to the back of the second leg).

In some embodiments, the elastic bands 206A and 206B are adjustable length bands to provide different tensioning relationships during walking. The elastic bands 206A and 206B may be polymer resistance bands or any other type of stretchable polymer and/or fabric with appropriate strength and resilience. As shown in FIGS. 5A and 5B, the elastic bands 206A and 206B may be coupled to the vest 202 and/or to the thigh braces 204A and 204B by a plurality of fasteners 210. In some embodiments, the fasteners 210 allow for the elastic bands 206A and 206B to be removably coupled so that elastic bands can be replaced or to allow for use of elastic bands with different levels of resistance, different dimensions, different weight ratings, etc. In some embodiments, the anterior band(s) 206A may have a different level of resistance, dimension, and/or weight rating than the posterior band(s) 206B. The anterior band(s) 206A and posterior band(s) 206B can also be independently adjustable. The fasteners 210 may also be configured to provide a mechanism for adjusting band tension (e.g., by tightening or loosening bands or by connecting the bands to different fastener locations). In embodiments, the fasteners 210 may include, but are not limited to, buttons, buckles, clasps, latches, clips, snap fasteners, loop fasteners, hook and eye fasteners, hook and loop fasteners (e.g., Velcro), seatbelt buckles, or any combination thereof.

The passive exosuit 200 may further include one or more straps and/or fasteners for securing the vest 202. For example, as shown in FIGS. 5A and 5B, one or more fasteners 208 may be secured across the front of the vest 202.

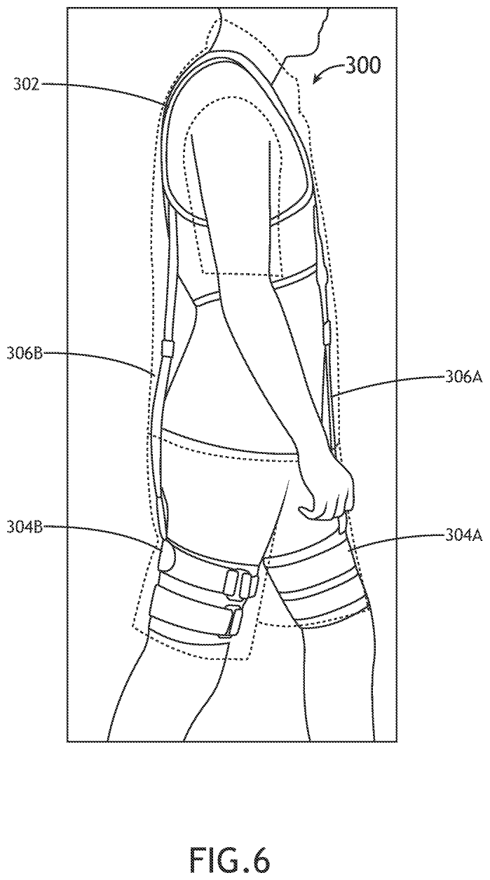

FIG. 6 illustrates another embodiment of a passive exosuit 300, wherein the first and second articles of apparel are thigh braces 304A and 304B, and wherein the third article of apparel is a pair of shoulder straps 302. Additionally, the passive exosuit 300 in FIG. 6 is configured to be worn as an undergarment, underneath the user's regular clothing.

Much like previously described embodiments, the first thigh brace 304A is configured to be worn on a user's first leg and the second thigh brace 304B is configured to be worn on a user's second leg. The thigh braces 304A and 304B may be secured about the user's first and second legs, respectively. In some embodiments, the thigh braces 304A and 304B wrap around the leg just above the knee. The thigh braces 304A and 304B may be secured by embedded elastic bands, straps, hook and loop fasteners (e.g., Velcro), buttons, buckles, clasps, any combination of the foregoing fasteners, or the like.

The shoulder straps 302 are coupled to the thigh braces 304A and 304B by one or more anterior elastic bands 306A extending from the shoulder straps 302 to the first thigh brace 304A and one or more posterior elastic bands 306B extending from the shoulder straps 302 to the second thigh brace 304B. The anterior band(s) 306A may be configured to impede hip extension of the first leg of the user, and the posterior band(s) 306B may be configured to impede hip flexion of the second leg of the user, or vice versa.

The elastic bands 306A and 306B may be further configured to assist movement in the opposite direction. This allows for energy to be stored and released throughout the entirety of the walking gait cycle. For example, energy is stored in the anterior band(s) 306A when impeding hip extension of the first leg while stepping forward with the second leg; using this energy, the anterior band(s) 306A can assist hip flexion of the first leg when the first leg is used to step forward. Similarly, energy is stored in the posterior band(s) 306B when impeding hip flexion of the second leg while stepping forward with the second leg; using this energy, the posterior band(s) 306B can assist hip extension of the second leg when the first leg is used to step forward.

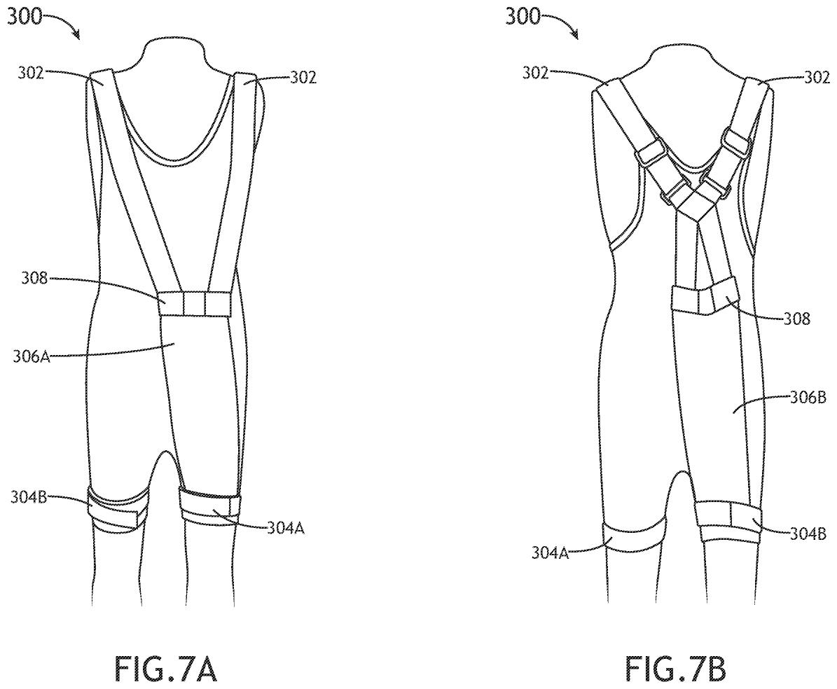

As shown in FIG. 7A, the anterior elastic band(s) 306A may be comprised of at least one form-fitting piece of elastic fabric connecting both of the shoulder straps 302 to the first thigh brace 304A in order to distribute hip extension impedance forces more evenly across the torso (e.g., across both shoulders). Similarly, as shown in FIG. 7B, the posterior elastic band(s) 306B may be comprised of at least one form-fitting piece of elastic fabric connecting both of the shoulder straps 302 to the second thigh brace 304B in order to distribute hip flexion impedance forces more evenly across the torso (e.g., across both shoulders).

Although specific embodiments are described above, it is contemplated that any number of anterior bands 306A and any number of posterior bands 306B may be utilized as long as they are arranged asymmetrically (i.e., anterior band(s) 306A connected to the front of the first leg and posterior band(s) 306B connected to the back of the second leg).

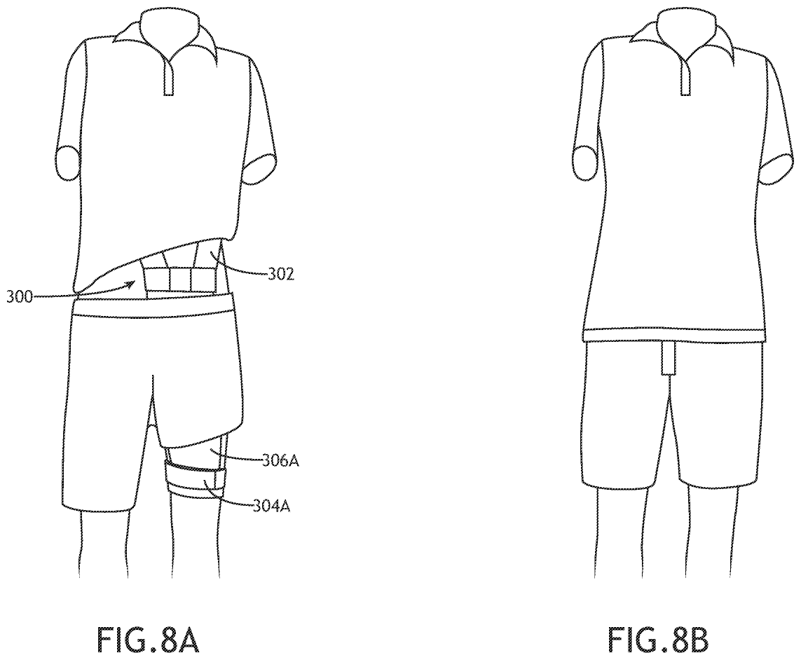

In some embodiments, the elastic bands 306A and 306B are adjustable length bands to provide different tensioning relationships during walking. However, it is also advantageous to provide a lightweight but non-adjustable or less adjustable exosuit 300 so that it fits better underneath the user's clothing. For example, see FIGS. 8A and 8B. As shown in FIGS. 7A and 7B, the elastic bands 306A and 306B may be sewn to the shoulder straps 302 either directly or with additional material (e.g., a band 308 of fabric, leather, faux leather, etc.) therebetween. The elastic bands 306A and 306B can also be sewn to the thigh braces 304A and 304B, respectively, either directly or with additional material therebetween. For example, in FIGS. 7A and 7B, the elastic bands 306A and 306B are sewn directly to the thigh braces 304A and 304B, respectively.

The elastic bands 306A and 306B are preferably made of an elastic/stretchable fabric that is form-fitting to the user's contours so that the passive exosuit 300 can be worn as an undergarment without showing or with minimal visibility. However, it is contemplated that the elastic bands 306A and 306B may comprise any form-fitting elastic polymer and/or fabric with appropriate strength and resilience.

The shoulder straps 302, thigh braces 304A and 304B, and elastic bands 306A and 306B may be sewn together into a one-piece passive exosuit 300. The passive exosuit 300 may be manufactured in different sizes and specifications to provide different levels of resistance, different dimensions, different weight ratings, etc. In some embodiments, the anterior band(s) 306A may have a different level of resistance, dimension, and/or weight rating than the posterior band(s) 306B. The anterior band(s) 306A and posterior band(s) 306B can also be independently adjustable. Alternatively, the elastic bands 306A and 306B may be coupled to the shoulder straps 302 and/or to the thigh braces 304A and 304B by a plurality of fasteners to allow for the elastic bands 306A and 306B to be removably coupled so that elastic bands can be replaced or to allow for use of elastic bands with different levels of resistance, different dimensions, different weight ratings, etc. Examples of appropriate fasteners include, but are not limited to, buttons, buckles, clasps, latches, clips, snap fasteners, loop fasteners, hook and eye fasteners, hook and loop fasteners (e.g., Velcro), seatbelt buckles, or any combination thereof.

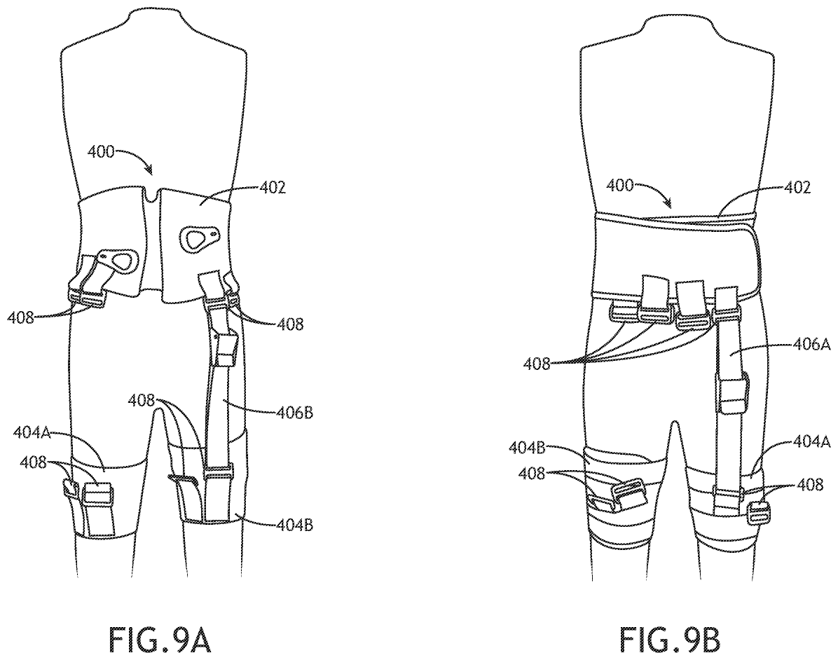

FIGS. 9A and 9B illustrate another embodiment of a passive exosuit 400, wherein the first and second articles of apparel are thigh braces 404A and 404B, and wherein the third article of apparel is a back or abdominal brace 402 (e.g., any type of band or brace that is worn about the waist or abdominal region of the torso). The first thigh brace 404A is configured to be worn on a user's first leg and the second thigh brace 404B is configured to be worn on a user's second leg.

The thigh braces 404A and 404B may be secured about the user's first and second legs, respectively. In some embodiments, the thigh braces 404A and 404B wrap around the leg just above the knee. The thigh braces 404A and 404B may be secured by embedded elastic bands, straps, hook and loop fasteners (e.g., Velcro), buttons, buckles, clasps, any combination of the foregoing fasteners, or the like.

The back or abdominal brace 402 is coupled to the thigh braces 404A and 404B by one or more anterior elastic bands 406A extending from the back or abdominal brace 402 to the first thigh brace 404A and one or more posterior elastic bands 406B extending from the back or abdominal brace 402 to the second thigh brace 404B. The anterior band(s) 406A may be configured to impede hip extension of the first leg of the user, and the posterior band(s) 406B may be configured to impede hip flexion of the second leg of the user, or vice versa.

The elastic bands 406A and 406B may be further configured to assist movement in the opposite direction. This allows for energy to be stored and released throughout the entirety of the walking gait cycle. For example, energy is stored in the anterior band(s) 406A when impeding hip extension of the first leg while stepping forward with the second leg; using this energy, the anterior band(s) 406A can assist hip flexion of the first leg when the first leg is used to step forward. Similarly, energy is stored in the posterior band(s) 406B when impeding hip flexion of the second leg while stepping forward with the second leg; using this energy, the posterior band(s) 406B can assist hip extension of the second leg when the first leg is used to step forward.

As shown in FIG. 9A, the anterior elastic band(s) 406A may be comprised of one or more elastic bands connecting the back or abdominal brace 402 to the first thigh brace 404A. In other embodiments, the anterior elastic band(s) 406A may be comprised of two or more elastic bands in order to distribute hip extension impedance forces more evenly across the torso (e.g., across both sides of the back, hips, etc.). Similarly, as shown in FIG. 9B, the posterior elastic band(s) 406B may be comprised of one or more elastic bands connecting the back or abdominal brace 402 to the second thigh brace 404B; but in other embodiments, the posterior elastic band(s) 406B may be comprised of two or more elastic bands in order to distribute hip flexion impedance forces more evenly across the torso (e.g., across both sides of the back, hips, etc.).

Although specific embodiments are described above, it is contemplated that any number of anterior bands 406A and any number of posterior bands 406B may be utilized as long as they are arranged asymmetrically (i.e., anterior band(s) 406A connected to the front of the first leg and posterior band(s) 406B connected to the back of the second leg).

In some embodiments, the elastic bands 406A and 406B are adjustable length bands to provide different tensioning relationships during walking. The elastic bands 406A and 406B may be polymer resistance bands or any other type of stretchable polymer and/or fabric with appropriate strength and resilience. The elastic bands 406A and 406B may be coupled to the back or abdominal brace 402 and/or to the thigh braces 404A and 404B by a plurality of fasteners. In some embodiments, the fasteners allow for the elastic bands 406A and 406B to be removably coupled so that elastic bands can be replaced or to allow for use of elastic bands with different levels of resistance, different dimensions, different weight ratings, etc. In some embodiments, the anterior band(s) 406A may have a different level of resistance, dimension, and/or weight rating than the posterior band(s) 406B. The anterior band(s) 406A and posterior band(s) 406B can also be independently adjustable. The fasteners may also be configured to provide a mechanism for adjusting band tension (e.g., by tightening or loosening bands or by connecting the bands to different fastener locations). In embodiments, the fasteners may include, but are not limited to, buttons, buckles, clasps, latches, clips, snap fasteners, loop fasteners, hook and eye fasteners, hook and loop fasteners (e.g., Velcro), seatbelt buckles, or any combination thereof.

Furthermore, a modular configuration of connectors 408 is shown in FIGS. 9A and 9B, where there are a plurality of the connectors 408 on either side of the back or abdominal brace 402 defining different attachment points for the elastic bands 406A and 406B so that the posterior band(s) 406A and the anterior band(s) 406B can be adjusted to accommodate different user specifications. The modular configuration of connectors 408 can also include a plurality of the connectors 408 on the thigh braces 404A and 404B also defining different attachment points for the elastic bands 406A and 406B.

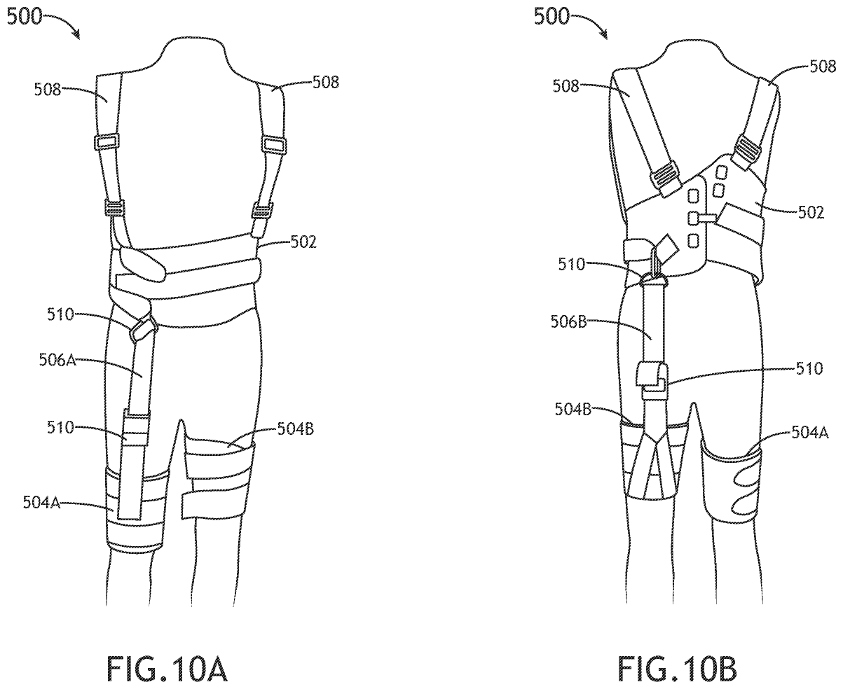

FIGS. 10A and 10B illustrate another embodiment of a passive exosuit 500, wherein the first and second articles of apparel are thigh braces 504A and 504B, and wherein the third article of apparel is a back or abdominal brace 502 (e.g., any type of band or brace that is worn about the waist or abdominal region of the torso). The first thigh brace 504A is configured to be worn on a user's first leg and the second thigh brace 504B is configured to be worn on a user's second leg.

The thigh braces 504A and 504B may be secured about the user's first and second legs, respectively. In some embodiments, the thigh braces 504A and 504B wrap around the leg just above the knee. The thigh braces 504A and 504B may be secured by embedded elastic bands, straps, hook and loop fasteners (e.g., Velcro), buttons, buckles, clasps, any combination of the foregoing fasteners, or the like.

The back or abdominal brace 502 is coupled to the thigh braces 504A and 504B by one or more anterior elastic bands 506A extending from the back or abdominal brace 502 to the first thigh brace 504A and one or more posterior elastic bands 506B extending from the back or abdominal brace 502 to the second thigh brace 504B. The anterior band(s) 506A may be configured to impede hip extension of the first leg of the user, and the posterior band(s) 506B may be configured to impede hip flexion of the second leg of the user, or vice versa.

The elastic bands 506A and 506B may be further configured to assist movement in the opposite direction. This allows for energy to be stored and released throughout the entirety of the walking gait cycle. For example, energy is stored in the anterior band(s) 506A when impeding hip extension of the first leg while stepping forward with the second leg; using this energy, the anterior band(s) 506A can assist hip flexion of the first leg when the first leg is used to step forward. Similarly, energy is stored in the posterior band(s) 506B when impeding hip flexion of the second leg while stepping forward with the second leg; using this energy, the posterior band(s) 506B can assist hip extension of the second leg when the first leg is used to step forward.

As shown in FIG. 10A, the anterior elastic band(s) 506A may be comprised of one or more elastic bands connecting the back or abdominal brace 502 to the first thigh brace 504A. In other embodiments, the anterior elastic band(s) 506A may be comprised of two or more elastic bands in order to distribute hip extension impedance forces more evenly across the torso (e.g., across both sides of the back, hips, etc.). Similarly, as shown in FIG. 10B, the posterior elastic band(s) 506B may be comprised of one or more elastic bands connecting the back or abdominal brace 502 to the second thigh brace 504B; but in other embodiments, the posterior elastic band(s) 506B may be comprised of two or more elastic bands in order to distribute hip flexion impedance forces more evenly across the torso (e.g., across both sides of the back, hips, etc.).

Although specific embodiments are described above, it is contemplated that any number of anterior bands 506A and any number of posterior bands 506B may be utilized as long as they are arranged asymmetrically (i.e., anterior band(s) 506A connected to the front of the first leg and posterior band(s) 506B connected to the back of the second leg).

In some embodiments, the elastic bands 506A and 506B are adjustable length bands to provide different tensioning relationships during walking. The elastic bands 506A and 506B may be polymer resistance bands or any other type of stretchable polymer and/or fabric with appropriate strength and resilience. The elastic bands 506A and 506B may be coupled to the back or abdominal brace 502 and/or to the thigh braces 504A and 504B by a plurality of fasteners 510. In some embodiments, the fasteners 510 allow for the elastic bands 506A and 506B to be removably coupled so that elastic bands can be replaced or to allow for use of elastic bands with different levels of resistance, different dimensions, different weight ratings, etc. In some embodiments, the anterior band(s) 506A may have a different level of resistance, dimension, and/or weight rating than the posterior band(s) 506B. The anterior band(s) 506A and posterior band(s) 506B can also be independently adjustable. The fasteners 510 may also be configured to provide a mechanism for adjusting band tension (e.g., by tightening or loosening bands or by connecting the bands to different fastener locations). In embodiments, the fasteners 510 may include, but are not limited to, buttons, buckles, clasps, latches, clips, snap fasteners, loop fasteners, hook and eye fasteners, hook and loop fasteners (e.g., Velcro), seatbelt buckles, or any combination thereof.

The passive exosuit 500 may further include a pair of suspenders 508 extending from the back or abdominal brace 502 over the user's shoulders for added support. The suspenders 508 may also help distribute a portion of the hip extension/extension impedance forces across the user's shoulders thereby reducing pressure on the user's lower back and hips.

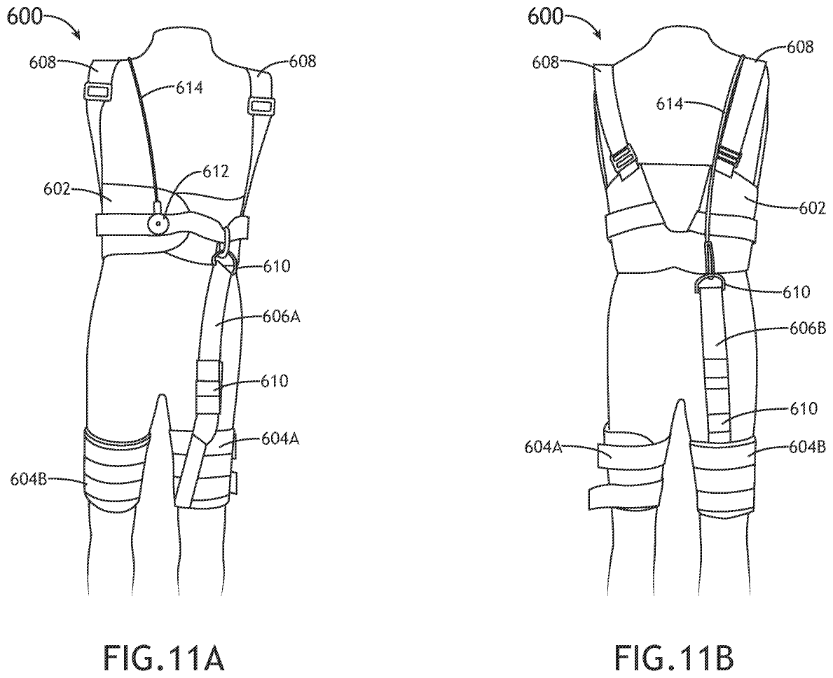

FIGS. 11A and 11B illustrate another embodiment of a passive exosuit 600, wherein the first and second articles of apparel are thigh braces 604A and 604B, and wherein the third article of apparel is a back or abdominal brace 602 (e.g., any type of band or brace that is worn about the waist or abdominal region of the torso). The first thigh brace 604A is configured to be worn on a user's first leg and the second thigh brace 604B is configured to be worn on a user's second leg.

The thigh braces 604A and 604B may be secured about the user's first and second legs, respectively. In some embodiments, the thigh braces 604A and 604B wrap around the leg just above the knee. The thigh braces 604A and 604B may be secured by embedded elastic bands, straps, hook and loop fasteners (e.g., Velcro), buttons, buckles, clasps, any combination of the foregoing fasteners, or the like.

The back or abdominal brace 602 is coupled to the thigh braces 604A and 604B by one or more anterior elastic bands 606A extending from the back or abdominal brace 602 to the first thigh brace 604A and one or more posterior elastic bands 606B extending from the back or abdominal brace 602 to the second thigh brace 604B. The anterior band(s) 606A may be configured to impede hip extension of the first leg of the user, and the posterior band(s) 606B may be configured to impede hip flexion of the second leg of the user, or vice versa.

The elastic bands 606A and 606B may be further configured to assist movement in the opposite direction. This allows for energy to be stored and released throughout the entirety of the walking gait cycle. For example, energy is stored in the anterior band(s) 606A when impeding hip extension of the first leg while stepping forward with the second leg; using this energy, the anterior band(s) 606A can assist hip flexion of the first leg when the first leg is used to step forward. Similarly, energy is stored in the posterior band(s) 606B when impeding hip flexion of the second leg while stepping forward with the second leg; using this energy, the posterior band(s) 606B can assist hip extension of the second leg when the first leg is used to step forward.

As shown in FIG. 11A, the anterior elastic band(s) 606A may be comprised of one or more elastic bands connecting the back or abdominal brace 602 to the first thigh brace 604A. In other embodiments, the anterior elastic band(s) 606A may be comprised of two or more elastic bands in order to distribute hip extension impedance forces more evenly across the torso (e.g., across both sides of the back, hips, etc.). Similarly, as shown in FIG. 11B, the posterior elastic band(s) 606B may be comprised of one or more elastic bands connecting the back or abdominal brace 602 to the second thigh brace 604B; but in other embodiments, the posterior elastic band(s) 606B may be comprised of two or more elastic bands in order to distribute hip flexion impedance forces more evenly across the torso (e.g., across both sides of the back, hips, etc.).

Although specific embodiments are described above, it is contemplated that any number of anterior bands 606A and any number of posterior bands 606B may be utilized as long as they are arranged asymmetrically (i.e., anterior band(s) 606A connected to the front of the first leg and posterior band(s) 606B connected to the back of the second leg).

In some embodiments, the elastic bands 606A and 606B are adjustable length bands to provide different tensioning relationships during walking. The elastic bands 606A and 606B may be polymer resistance bands or any other type of stretchable polymer and/or fabric with appropriate strength and resilience. The elastic bands 606A and 606B may be coupled to the back or abdominal brace 602 and/or to the thigh braces 604A and 604B by a plurality of fasteners 610. In some embodiments, the fasteners 610 allow for the elastic bands 606A and 606B to be removably coupled so that elastic bands can be replaced or to allow for use of elastic bands with different levels of resistance, different dimensions, different weight ratings, etc. In some embodiments, the anterior band(s) 606A may have a different level of resistance, dimension, and/or weight rating than the posterior band(s) 606B. The anterior band(s) 606A and posterior band(s) 606B can also be independently adjustable. The fasteners 610 may also be configured to provide a mechanism for adjusting band tension (e.g., by tightening or loosening bands or by connecting the bands to different fastener locations). In embodiments, the fasteners 610 may include, but are not limited to, buttons, buckles, clasps, latches, clips, snap fasteners, loop fasteners, hook and eye fasteners, hook and loop fasteners (e.g., Velcro), seatbelt buckles, or any combination thereof.

The passive exosuit 600 may further include a pair of suspenders 608 extending from the back or abdominal brace 602 over the user's shoulders for added support. The suspenders 608 may also help distribute a portion of the hip extension/extension impedance forces across the user's shoulders thereby reducing pressure on the user's lower back and hips.

The passive exosuit 600 illustrated in FIGS. 11A and 11B is further equipped with a mechanism for adjusting tension in the posterior band(s) 606B using a dial 612 located at the front of the passive exosuit 600. For example, the dial 612 may be coupled to the front of the back or abdominal brace 602 so that it can be easily reached and manipulated by the user. In embodiments, the dial 212 is configured to control tension of the posterior band(s) 606B by tightening or loosening a cable 614 that extends over the user's shoulder to the posterior band(s) 606B. The cable 614 is coupled to the posterior band(s) 606B by one or more of the fasteners 610. This mechanism allows the user to adjust tension in the posterior band(s) by themselves after donning the passive exosuit 600.

As previously noted, portions of the passive exosuit embodiments (e.g., portions of passive exosuit 100, 200, 300, 400, 500, and/or 600) can be combined to achieve an additional embodiment that is not necessarily shown or described with reference to one drawing. As such, the drawings and associated descriptions should not be construed as restrictive of any particular embodiment and are intended instead as visual aids to help describe configurations of certain components that may apply to multiple embodiments of the passive exosuit. For example, any of the embodiments described above may benefit from including two or more anterior/posterior elastic bands for better distribution of forces across the torso, adjustable fasteners, modular connectors, additional suspenders/straps for added support, and/or adjustment mechanisms allowing the user to control tension in posterior band(s) from a front of the passive exosuit. Any such embodiments are encompassed by the present disclosure.

Although bilateral embodiments of the passive exosuit (as described above) are the focus of this disclosure, a unilateral embodiment of the passive exosuit is also provided. In a unilateral embodiment, the passive exosuit includes: an article of apparel configured to be worn on at least a portion of a torso of a user; another article of apparel configured to be worn on at least a portion of a selected leg of the user; and at least one elastic band connecting the articles of apparel to one another (i.e., at least one anterior band configured to impede hip extension of the selected leg of the user OR at least one posterior band configured to impede hip flexion of the selected leg of the user).

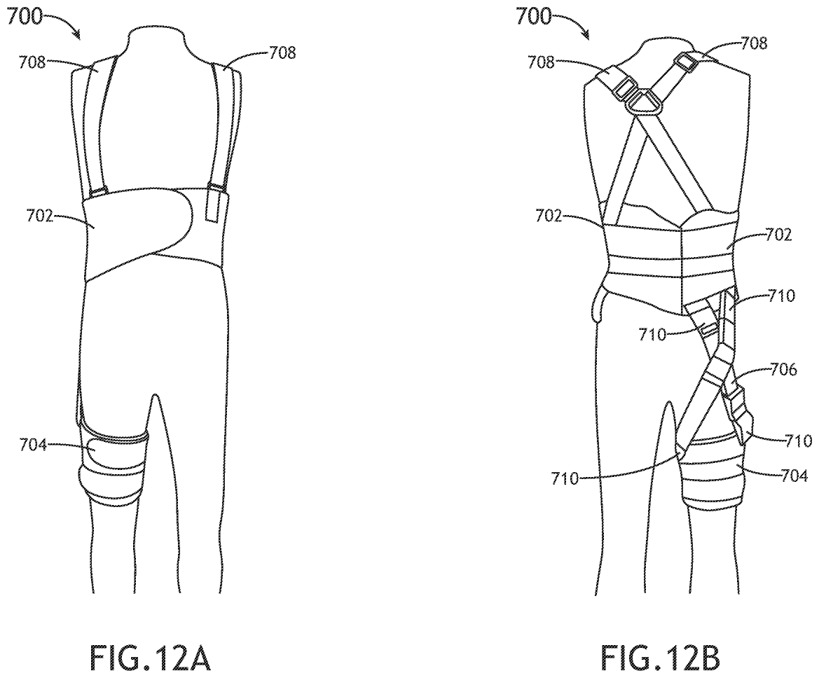

FIGS. 12A and 12B illustrate a unilateral embodiment of a passive exosuit 700, wherein the leg-worn article of apparel is a thigh brace 704, and wherein the torso-worn article of apparel is a back or abdominal brace 702 (e.g., any type of band or brace that is worn about the waist or abdominal region of the torso).

The thigh brace 704 may be secured about a selected leg of the user. In some embodiments, the thigh brace 704 wraps around the leg just above the knee. The thigh brace 704 may be secured by embedded elastic bands, straps, hook and loop fasteners (e.g., Velcro), buttons, buckles, clasps, any combination of the foregoing fasteners, or the like.

The back or abdominal brace 702 is coupled to the thigh brace 704 by one or more anterior or posterior elastic bands 706 extending from the back or abdominal brace 702 to the brace 704. Anterior band(s) may be configured to impede hip extension of the selected leg, or posterior band(s) may be configured to impede hip flexion of the selected leg.

The elastic band(s) 706 may be further configured to assist movement in the opposite direction. This allows for energy to be stored and released throughout the entirety of the walking gait cycle. For example, energy is stored in an anterior band when impeding hip extension of the selected leg while stepping forward with the other leg; using this energy, an anterior band can assist hip flexion of the selected leg when that leg is used to step forward. Similarly, energy is stored in a posterior band when impeding hip flexion of the selected leg while stepping forward with that leg; using this energy, a posterior band can assist hip extension of the selected leg when the other leg is used to step forward.

As shown in FIG. 12B, elastic band(s) 706 may be comprised of two or more elastic bands connecting the back or abdominal brace 702 to the thigh brace 704 in order to distribute hip extension impedance forces more evenly across the back or abdominal brace 702.

Although specific embodiments are described above, it is contemplated that any number of elastic bands 706 may be utilized as long as they are arranged asymmetrically (i.e., anterior band(s) connected to the front of a selected leg OR posterior band(s) connected to the back of the selected leg).

In some embodiments, the elastic band(s) 706 are adjustable length bands to provide different tensioning relationships during walking. The elastic band(s) 706 may be polymer resistance bands or any other type of stretchable polymer and/or fabric with appropriate strength and resilience. The elastic band(s) 706 may be coupled to the back or abdominal brace 702 and/or to the thigh brace 704 by a plurality of fasteners 710. In some embodiments, the fasteners 710 allow for the elastic band(s) 706 to be removably coupled so that the elastic band(s) 706 can be replaced or to allow for use of elastic bands with different levels of resistance, different dimensions, different weight ratings, etc. The fasteners 710 may also be configured to provide a mechanism for adjusting band tension (e.g., by tightening or loosening bands or by connecting the bands to different fastener locations). In embodiments, the fasteners 710 may include, but are not limited to, buttons, buckles, clasps, latches, clips, snap fasteners, loop fasteners, hook and eye fasteners, hook and loop fasteners (e.g., Velcro), seatbelt buckles, or any combination thereof.

The passive exosuit 700 may further include a pair of suspenders 708 extending from the back or abdominal brace 702 over the user's shoulders for added support. The suspenders 708 may also help distribute a portion of the hip extension/extension impedance forces across the user's shoulders thereby reducing pressure on the user's lower back and hips.

A method for asymmetry rehabilitation may employ any embodiment of the passive exosuit described above (e.g., passive exosuit 100, 200, 300, 400, 500, 600, or 700) or any embodiment achieved by variation or combination of the passive exosuit embodiments described above.

In implementations, the method of performing asymmetry rehabilitation includes steps of: (i) assessing gait asymmetry affecting a user by determining a difference between step lengths when advancing with a first leg of the user versus advancing with a second leg of the user; and (ii) donning the passive exosuit on the user, wherein the elastic band(s) are configured to increase the difference between the step lengths when advancing with the first leg of the user versus advancing with the second leg of the user, thereby causing the user to overcompensate for the difference between the step lengths while wearing the passive exosuit and then walk with improved gait symmetry upon removing the passive exosuit as a result of said overcompensation.

Users may perform rehabilitation for shorter periods of time at high resistance or over a long period of time with lower resistance. It is contemplated that use of the passive exosuit for longer periods of time will yield permanent or longer lasting improvements to gait symmetry. In this regard, the method of performing asymmetry rehabilitation may include additional steps of qualitatively or quantitatively assessing the user's compliance (i.e., the user's tolerance to band resistance and/or willingness to wear the passive exosuit for an extended period of time). The band resistance may be adjusted based on such assessments. For example, the band resistance may be increased to yield greater improvements to gait symmetry if the user exhibits a high level of compliance. Conversely, the band resistance may be relaxed to improve comfort and yield higher compliance if the user refuses to wear the passive exosuit or exhibits a high level of pain/discomfort when wearing the device. Higher levels of compliance may also be achieved with embodiments of the passive exosuit where band resistance can be adjusted by the users themselves. This allows users to train more often at their own pace.

Although the technology has been described with reference to the embodiments illustrated in the attached drawing figures, equivalents may be employed, and substitutions may be made herein without departing from the scope of the technology as recited in the claims. Components illustrated and described herein are examples of devices and components that may be used to implement the embodiments of the present invention and may be replaced with other devices and components without departing from the scope of the invention. Furthermore, any dimensions, degrees, and/or numerical ranges provided herein are to be understood as non-limiting examples unless otherwise specified in the claims.

What is claimed is:

1. A passive exosuit for asymmetry rehabilitation, comprising:
a first article of apparel configured to be worn on at least a portion of a first leg;
a second article of apparel configured to be worn on at least a portion of a second leg;
a third article of apparel configured to be worn on at least a portion of a torso; and
a plurality of elastic bands asymmetrically connecting the third article of apparel to the first and second articles of apparel, the plurality of elastic bands including at least one anterior band configured to impede hip extension of the first leg and at least one posterior band configured to impede hip flexion of the second leg.

2. The passive exosuit of claim 1, wherein the first and second articles of apparel comprise thigh braces.

3. The passive exosuit of claim 1, wherein the third article of apparel comprises a pair of shoulder straps.

4. The passive exosuit of claim 3, wherein the third article of apparel further comprises a chest strap extending between the pair of shoulder straps for added support.

5. The passive exosuit of claim 1, wherein the third article of apparel comprises a vest.

6. The passive exosuit of claim 1, wherein the third article of apparel comprises a back or abdominal brace.

7. The passive exosuit of claim 6, wherein the third article of apparel further comprises a pair of suspenders extending from the back or abdominal brace for added support.

8. The passive exosuit of claim 1, wherein the at least one anterior band is comprised of two or more elastic bands connecting the third article of apparel to the first article of apparel in order to distribute hip extension impedance forces more evenly across the torso.

9. The passive exosuit of claim 1, wherein the at least one posterior band is comprised of two or more elastic bands connecting the third article of apparel to the second article of apparel in order to distribute hip flexion impedance forces more evenly across the torso.

10. The passive exosuit of claim 1, wherein the third article of apparel includes a plurality of connectors defining different attachment points for the plurality of elastic bands so that the at least one posterior band and the at least one anterior band can be adjusted to accommodate different user specifications.

11. The passive exosuit of claim 1, further comprising:
a dial located at a front of the third article of apparel, the dial configured to control tension of the least one posterior band by tightening or loosening a cable that extends over a shoulder of the torso to the at least one posterior band.

12. The passive exosuit of claim 1, wherein the plurality of elastic bands are removably coupled to the first, second, and third articles of apparel by fasteners.

13. The passive exosuit of claim 12, wherein the fasteners comprise at least one of: buttons, buckles, clasps, latches, clips, snap fasteners, loop fasteners, hook and eye fasteners, hook and loop fasteners, or seatbelt buckles.

14. The passive exosuit of claim 1, wherein the plurality of elastic bands comprise polymer resistance bands.

15. The passive exosuit of claim 1, wherein the plurality of elastic bands are sewn to the first, second, and third articles of apparel.

16. The passive exosuit of claim 15, wherein the passive exosuit is configured to be worn as an undergarment.

17. The passive exosuit of claim 16, wherein the plurality of elastic bands comprise form-fitting pieces of elastic fabric.

18. A method of performing asymmetry rehabilitation, comprising:
assessing gait asymmetry affecting a user by determining a difference between step lengths when advancing with a first leg of the user versus advancing with a second leg of the user; and
donning a passive exosuit on the user, the passive exosuit comprising: a first article of apparel configured to be worn on at least a portion of the first leg of the user; a second article of apparel configured to be worn on at least a portion of the second leg of the user; a third article of apparel configured to be worn on at least a portion of a torso of the user; and a plurality of elastic bands asymmetrically connecting the third article of apparel to the first and second articles of apparel, the plurality of elastic bands including at least one anterior band configured to impede hip extension of the first leg of the user and at least one posterior band configured to impede hip flexion of the second leg of the user,
wherein the plurality of elastic bands are configured to increase the difference between the step lengths when advancing with the first leg of the user versus advancing with the second leg of the user, thereby causing the user to overcompensate for the difference between the step lengths while wearing the passive exosuit and then walk with improved gait symmetry upon removing the passive exosuit as a result of said overcompensation.

19. A passive exosuit for asymmetry rehabilitation, comprising:
an article of apparel configured to be worn on at least a portion of a torso;
another article of apparel configured to be worn on at least a portion of a leg; and
at least one elastic band connecting the articles of apparel to one another, the at least one elastic band comprising at least one anterior band configured to impede hip extension of the leg or at least one posterior band configured to impede hip flexion of the leg.

20. A method of performing asymmetry rehabilitation, comprising:
assessing gait asymmetry affecting a user by determining a difference between step lengths when advancing with a first leg of the user versus advancing with a second leg of the user; and
donning a passive exosuit on the user, the passive exosuit comprising: an article of apparel configured to be worn on at least a portion of a torso of the user;
another article of apparel configured to be worn on at least a portion of the first leg of the user; and at least one elastic band connecting the articles of apparel to one another, the at least one elastic band comprising at least one anterior band configured to impede hip extension of the first leg of the user or at least one posterior band configured to impede hip flexion of the first leg of the user,
wherein the at least one elastic band is configured to increase the difference between the step lengths when advancing with the first leg of the user versus advancing with the second leg of the user, thereby causing the user to overcompensate for the difference between the step lengths while wearing the passive exosuit and then walk with improved gait symmetry upon removing the passive exosuit as a result of said overcompensation.
